(19) United States
(12) Patent Application Publication
(10) Pub. No.: US 2010/0134569 A1
(43) Pub. Date: Jun. 3, 2010

(54) CONTINUOUS INKJET PRINTERS

(76) Inventor: Frank Wilhelm Rohlfing, Cambridge (GB)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/595,259

(22) PCT Filed: Apr. 9, 2008
(86) PCT No.: PCT/GB08/01231

§ 371 Date: Jan. 19, 2010

(30) Foreign Application Priority Data
Apr. 10, 2007 (GB) 0706801.8

(51) Int. Cl. B41J 2/085

(52) U.S. Cl. 347/76

(57) ABSTRACT

The invention describes a print-head for a continuous inkjet printer having a charge electrode array in which each charge electrode in the array is relatively wide (W) compared to the spacing (s-W) between the electrode. Preferably the width is an order of magnitude greater than the spacing.

### FIELD OF THE INVENTION

This invention relates to continuous inkjet (CIJ) printers and, in particular, though not necessarily solely, to a charge electrode array for a binary continuous inkjet printer used for coding and marking applications. These printers typically have print resolution in the order of 120 dpi and are to be contrasted with high resolution printers having a print resolution of at least 500 dpi.

### BACKGROUND TO THE INVENTION

CIJ printing involves the formation of electrically charged drops from a jet of ink, and the subsequent deflection of the charged drops by an electric field to produce an image on a print medium. Electrically conducting ink is forced through a nozzle or through an array of nozzles. As a result of surface tension, the ink jet(s) break up into drops.

In a CIJ print-head, a controlled sequence of drops, each with identical drop volume, and with constant separation between adjacent drops, can be formed by modulating the jet or the array of jets in a controlled fashion. This can be achieved by modulating the ink pressure or the ink velocity relative to the nozzle, in a sinusoidal way, at fixed frequency and amplitude. A range of options and techniques to induce pressure modulation, velocity modulation or a combination of both, so that uniform drop sequences are obtained, are known to those skilled in the art. The most widespread of these known techniques is ultra-sonic agitation with piezo-electric crystals, converting electrical energy into mechanical energy.

Charge is induced on individual ink drops through a charge electrode that is located in the vicinity of the position at which the drops separate from their jet. Charge flows onto the conducting jet through capacitive coupling between the electrode and the jet. If a printer uses more than one jet (the jets being typically arranged in a linear array) each jet will have its own charge electrode.

Desired levels of charge are induced on drops by applying a voltage to the electrode at the time the drop separates from the jet. The charge electrode voltage is updated whenever a drop separates from its jet. Hence electrodes and jets are modulated at the same frequency, and great care is taken to ensure a suitable phase relationship is maintained between the two signals so that the correct voltage is present at the time of drop separation.

After charging, the ink drops travel through a constant electric field whose field lines are substantially perpendicular to the jet. Charged drops are deflected by an amount that scales with the charge on the drops.

The technique described here enables the printing of an image, consisting of a plurality of drops, on a print medium.

For commercial applications, CIJ printers with a single jet, or a linear array of identical jets having associated nozzles and charge electrodes with a fixed pitch, are used. In both cases, the electric field through which drops travel is kept constant. In single-jet printers, a range of charge voltages is used to achieve different degrees of deflection. Uncharged drops are not deflected and fall into a vacuum re-flow, often referred to as gutter or catcher, for subsequent re-use of the un-printed ink. In a multi-jet printer, uncharged drops are used for printing and deflected drops are charged with a fixed voltage so that they are deflected into a gutter for ink re-flow and subsequent re-use.

As there are no intermediate charge levels in the latter kind of CIJ printer (drops are either charged to reach the gutter or not charged enabling them to travel past the gutter and impinge on the print medium), these are often referred to as binary printers.

The present invention mainly applies to binary printers, but some aspects of the invention are also relevant to printers using a single jet.

A schematic cross section of a typical binary print-head is shown in FIG. 1. The charge electrodes, deflector plates and gutter are indicated. An auxiliary electrode, also indicated, is required to shield drops from the deflector plates when they separate from their jets.

A cross section of a typical charge electrode array, with associated jets and as found in a commercial binary printer, is shown in FIG. 2. Binary printers typically have 100 to 500 jets and associated charge electrodes, arranged in a single line, with a pitch s between adjacent electrodes of, typically, 100-300 μm. For illustrative purposes, only three jets and their corresponding charge electrodes are shown in FIG. 2. A resolution of 120 dpi (dots per 20 inch) is often used in commercial printers, which corresponds to a pitch s of 212 μm. The jet radius R is typically 20-50 μm.

It is important to mention that conventional prior art binary printers are based on charge-electrode designs in which the electrode width W is comparable to, or smaller than, the separation s-W between adjacent electrodes. The charge electrodes have to be sufficiently long to guarantee that the break-up position (the position at which drops separates from their jet) falls well within the charge electrode area. A charge electrode length of, typically, 1 mm is generally sufficient to guarantee this.

One of the key shortcomings of conventional charge-electrode arrays, when of the form as shown in FIG. 2 in which the electrode width W is comparable in dimension to or smaller than the spacing s-W between electrodes, is that artefacts arise in the printed image due to stray capacitances arising between a jet and its neighbouring charge electrodes. For instance, if a jet produces a printed drop at the same time as its neighbouring jets produce a deflected, non-printed drop, the neighbouring charge electrodes will induce a small charge on the printed drop due to capacitive cross-talk. This small charge will, in turn, result in a small degree of deflection, moving the drop away from its idealised print position. If, however, the neighbouring jets also produce a printed drop, their charge electrodes will be set to ground, and no charge due to cross-coupling from neighbouring charge electrodes will be induced. Hence, the position of printed drops is not constant but depends on whether or not a deflecting voltage is applied to neighbouring charge electrodes.

The extent of capacitive cross-talk depends on the dimensions of the charge electrode array, the separation between the jets and the charge electrode array, and the dielectric constant of the charge electrode substrate and any encapsulation layers that may be present on top of the charge electrodes to prevent degradation or corrosion from the ink. Intuition would suggest that the closer adjacent charge electrodes are positioned, the greater the capacitive cross-talk.

Another disadvantage of conventional charge-electrode arrays, when of the form shown in FIG. 2, is that cross-talk due to fringing fields introduces a spread in deflection among non-printed drops. This spread in deflection complicates the separation of printed and non-printed drops by the edge of the gutter, as the ease with which drops can be separated is limited by the position of the least-deflected, non-printed drop rather than by the average deflection of all non-printed drops. For example, if a jet produces a deflected, non-printed, drop at the same time as its neighbouring jets produce printed drops, its drop charge will be reduced due to capacitive coupling of its charge electrode with its neighbouring jets and associated charge electrodes, compared to the drop charge induced on a deflected, non-printed, drop whose neighbouring jets also produce deflected, non-printed, drops. In particular, a deflected, non-printed drop experiences the largest degree of deflection if its nearest neighbours are also deflected into the gutter, whilst the lowest degree of deflection is observed in deflected, non-printed drops whose nearest neighbours are all printed drops. Hence the position of non-printed drops within the gutter is not constant but depends on whether or not a deflecting voltage is applied to neighbouring charge electrodes.

As with the extent of capacitive cross-talk, the spread in deflection of non-printed drops depends on the dimensions of the charge electrode array, the separation between jets and the charge electrode array, and the dielectric constant of the charge electrode substrate and any encapsulation layers that may be present to prevent degradation or corrosion from the ink. Again, intuition suggests that the spread of deflection of non-printed drops will be greater, the closer the charge electrodes are to one another.

Yet a further shortcoming of conventional charge-electrode arrays, as illustrated, in FIG. 2, is that artefacts arise in the printed image due to capacitive coupling between a drop or sequence of drops and the jet from which the drop or the sequence of drops separated. For example, if a jet produces a printed drop, immediately after a non-printed drop or sequence of non-printed drops separated from the same jet, the charge on the non-printed drop or sequence of drops will induce through capacitive coupling an opposite charge onto the section of the jet that is forming the printed drop, causing a small deflection in the direction opposite to the deflection direction on non-printed drops. This moves the printed drop away from its ideal position on the print medium, resulting in visible artefacts in the print image.

As with the shortcomings described above, the deviation of the printed drop from its ideal position due to capacitive coupling between jet and drops depends on the dimensions of the charge electrode array, as well as on the separation between the jets and the charge electrode array, and the dielectric constant of the charge electrode substrate and any encapsulation layers that may be present to prevent degradation or corrosion from the ink. As with the examples described above, intuition suggests that this capacitive coupling will decrease with increasing s.

It is an object of this invention to provide a print-head configuration for a continuous inkjet printer which will go at least some way in addressing the drawbacks described above; or which will at least provide a novel and effective choice.

### SUMMARY OF THE INVENTION

In one aspect the invention provides a print-head for a continuous inkjet printer having a plurality of jets and a plurality of spaced charge electrodes, each of said charge electrodes having a width W and arranged at a pitch s, said print-head being characterized in that the width W of each electrode is greater than the spacing s-W between adjacent electrodes and is greater than the spacing between said jets and said electrodes.

Preferably the width W is one order of magnitude greater than the spacing s-W between adjacent charge electrodes.

Preferably the width W is at least 1.8 times the distance between said jets and said electrodes.

Preferably said charge electrodes are formed from a metal, a conducting polymer or a doped semiconductor.

Preferably said charge electrodes are carried on a substrate of alumina or zirconia.

Preferably said charge electrodes are overlaid with an encapsulation layer of silicon nitride or a combination of silicon oxide and silicon nitride.

In a second aspect the invention provides a binary continuous inkjet printer having a print-head as set forth above.

Many variations in the way the present invention can be performed will present themselves to those skilled in the art. The description which follows is intended as an illustration only of one means of performing the invention and the lack of description of variants or equivalents should not be regarded as limiting. Wherever possible, a description of a specific element should be deemed to include any and all equivalents thereof whether in existence now or in the future.

### BRIEF DESCRIPTION OF THE DRAWINGS

A working embodiment of the invention will now be described with reference to the accompanying drawings in which:

FIG. 1: shows a schematic elevational view of a typical continuous inkjet print-head aligned to print vertically downwards:

FIG. 2: shows an enlarged cross-section through part of a typical prior art charge electrode array; and

FIG. 3: shows an enlarged cross-section through part of a typical charge electrode array embodying the invention.

### DETAILED DESCRIPTION OF WORKING EMBODIMENT

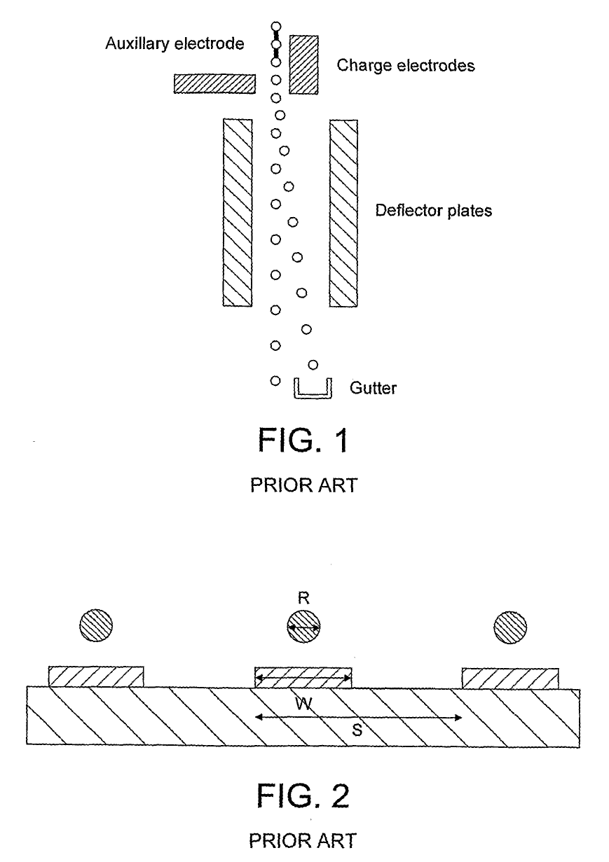

The general arrangement of both a continuous inkjet (CIJ) print-head and a charge electrode array used in such a print-head has been described above with reference to FIGS. 1 and 2. The present invention is based on the unexpected observation that, by making the individual electrodes wide with respect to the spacing between them, capacitive cross-talk between jets and charge electrodes, as well as capacitive coupling between drops and jets, are reduced. Cross-talk capacitance decreases with increasing electrode width and 15 this happens more rapidly for small jet to electrode spacings. Configuring the charge electrode array and jet to electrode spacing, in response to this observation, results in enhanced print quality and a reduced spread in the deflection of non-printed drops. This is the opposite of what might be expected intuitively.

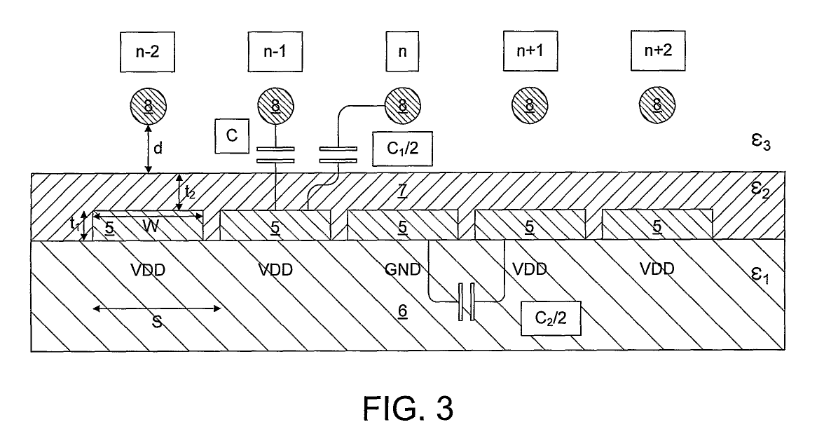

Referring now to FIG. 3, a cross-section is shown of a general coplanar charge electrode array architecture, including jets. Electrodes 5, each arranged at a pitch s, and having a width W and thickness t₁, are deposited on a substrate 6 having a relative permittivity ∈₁. Once the electrodes 5 have been set in place, an encapsulation layer 7 having a thickness t₂ and a relative permittivity ∈₂ is deposited over the substrate 6 and electrodes 5.

The electrodes may be fabricated from a metal or any other material with a sufficient conductivity, such as a conducting polymer or a doped semiconductor.

The individual ink jets 8 are at positions spaced a distance d from their respective electrodes, d being measured from the top of the encapsulation layer 7. This invention includes embodiments that do not require an encapsulation layer, in which case the separation distance d is measured from the top surfaces of the charge electrodes 5. The ink jets travel through a gas (typically air) having a dielectric constant ∈₃.

The charge-electrode substrate may be formed from a range of non-conducting materials with suitable mechanical and dielectric properties. Suitable materials will be well known to those skilled in the art but include ceramic materials such as alumina or zirconia due to their superior mechanical properties and resistance to organic solvents and other corrosive materials typically found in inks. Alumina and zirconia also display favourable thermal expansion coefficients and dielectric constants.

Ceramic substrates are typically post-processed to reduce surface roughness to a level that is very small compared to the separation between jets and charge electrodes. Those skilled in the art will be aware of various suitable techniques to achieve this, such as polishing or lapping, and sub-micron surface roughness can be achieved.

Following substrate processing, a metal layer, a sequence of different metal layers, metal-alloy layers or a sequence of different metal-alloy layers are 25 deposited onto the substrate via chemical vapour deposition, or sputtering, through a shadow mask to form an array of electrodes. Alternatively, metal electrodes may be defined after layer deposition using photo-lithography, followed by dry or wet etching. The advantage of this technique compared to the use of a shadow mask is that it enables finer feature sizes which, in turn, allow a smaller gap to be formed between adjacent electrodes without the risk of short circuits. Electrode material may also be deposited from a solution mixture via spin coating followed by photo-lithographic definition of electrodes.

As illustrated in FIG. 3, designs with an encapsulation layer 7 on top of the charge electrodes are included in this invention. In the embodiment of the invention described herein, the encapsulation layer 7 comprises a silicon oxide layer deposited through sputtering. A silicon nitride layer, or a combination of silicon oxide and silicon nitride layer, may also be used.

The following describes the electric capacitances that are present in the charge electrode and jet arrangement shown in FIG. 3. Electrodes n−2, n−1, n+1 and n+2 are set to a positive voltage VDD and electrode n is set to ground. A typical voltage range for VDD is 50-200V. With the conditions present as shown in FIG. 3, jets n−2, n−1, n+1 and n+2 produce a drop that is deflected into the gutter, whilst jet n produces a printed drop. In a two-dimensional model, as indicated in FIG. 3, there will be a capacitance C per unit length between a jet and its charge electrode, as indicated between jet n−1 and electrode n−1 in FIG. 3. Due to fringing effects of the electric field, there will be capacitive cross-talk between jet n and its neighbouring electrodes n−1 and n+1. This effect results in a stray capacitance C₁ per unit length. Similarly, there will be coupling between electrode n and electrodes n−1 and n+1, resulting in a capacitance C₂ per unit length.

For printing applications, the objective is to achieve a charge electrode design that produces a large value for C to achieve maximum deflection, and a small value for C₁ to reduce image artefacts due to cross-talk. A design in which the capacitance C₁ is insensitive to variations in width W and separation d, due to variations in the charge electrode manufacturing process or misalignment of the jets relative to the charge electrode array, is preferred.

C, C₁ and C₂ depend on width W, electrode pitch s, separation d, thicknesses t₁ and t₂, and also on the dielectric properties of the substrate and the encapsulation layer. This invention provides a charge electrode design with parameters that substantially optimises C and C₁ to reduce the effect of cross-talk on print quality and to reduce the spread of non-printed drops.

In order to quantify the advantages of this invention, we compare a specific conventional charge electrode design with s=200 μm and W=100 μm (referring again to FIG. 3) to a specific embodiment of this invention with s=200 μm and W=180 μm. In the following, the conventional design is referred to as CEA1 and the latter inventive design as CEA2.

In both cases the jet radius is 20 μm and the jet-to-electrode separation ranges between 30 μm and 100 μm. Hence for both CEA1 and CEA2, the jet-to-electrode spacing is small or comparable to the width W.

Theoretical investigations using finite-element analysis to solve the Poisson equation under the boundary conditions illustrated in FIG. 3, in combination with experimental studies, reveal the following differences between CEA1 and CEA2:
1. In design CEA2, the stray capacitance C₁ is reduced by 21% and C is increased by 3%, when compared to CEA1, for an intermediate separation d=50 μm.
2. Over a separation range of d=30 μm to d=100 μm, C₁ changes by 17% in CEA1, and by only 2.3% in CEA2.
3. In CEA2, both C and C₁ are virtually independent of the dielectric constant between ∈=10 (alumina substrate) and ∈=30 (zirconia substrate): C and C₁ change by less than 0.5% over this range, making jet charging efficiency, and cross-talk, substantially insensitive to any variations in the dielectric properties of the substrate.
4. In CEA2, for an intermediate separation d=50 μm, the spread in deflection of non-printed drops is reduced by 22%.
5. In CEA2, for an intermediate separation of d=50 μm, the charge induced on a printed drop due to capacitive interaction of its jet prior to its separation from it, with a previously separated, non-printed drop, is reduced by 20% compared to design CEA1.

Thus, compared to conventional charge-electrode arrays, a print-head having a charge electrode array configured in accordance with the invention has the following advantages:
i) Print quality is improved due to a reduction of residual charge on printed drops as a result of capacitive cross-talk.
ii) The capacitance between each jet and its respective charge electrode is increased, giving better charging efficiency.
iii) In conventional designs with narrow charge electrodes, the stray capacitance changes significantly with jet-to-electrode separation. However, if the gap between electrodes is very small compared to the width, the stray capacitance becomes substantially independent of jet-to-electrode separation over a large range, eliminating the sensitivity of stray capacitance due to misalignment between the nozzle array and the charge electrode array.
iv) The stray capacitance becomes substantially insensitive to variations in the dielectric constant of the charge electrode substrate or that of any encapsulation layer deposited on top of the charge electrode.
v) The capacitive coupling between a jet and its drops is reduced.
vi) There is a spread in the position of the deflected drops within the gutter, as a result of different degrees of capacitive coupling, depending on the image to be printed. With wide electrodes in accordance with the invention, this spread is smaller thus increasing the separation between a printed drop and the least-deflected, non-printed drops. Depending on the charge electrode array, and print head, configurations, this enables the use of reduced deflector plate or charge electrode voltages.

1. A print-head for a continuous inkjet printer comprising a plurality of jets and a plurality of spaced charge electrodes, each of said charge electrodes having a width W and arranged at a pitch s, said print-head wherein the width W of each electrode is greater than the spacing s-W between adjacent electrodes and is greater than the spacing between said jets and said electrodes.

2. A print-head as claimed in claim 1 wherein the width W is one order of magnitude greater than the spacing s-W between adjacent charge electrodes.

3. A print-head as claimed in claim 1 wherein the width W is at least 1.8 times the distance between said jets and said electrodes.

4. A print-head as claimed in claim 1 wherein said charge electrodes are formed from a metal, a conducting polymer or a doped semiconductor.

5. A print-head as claimed in claim 1 wherein said charge electrodes are carried on a substrate of alumina or zirconia.

6. A print-head as claimed in claim 1 wherein said charge electrodes are overlaid with an encapsulation layer of silicon nitride or a combination of silicon oxide and silicon nitride.

7. A binary continuous inkjet printer having a print-head as claimed in claim 1.
